(19) United States
(12) Patent Application Publication
(10) Pub. No.: US 2025/0306448 A1
(43) Pub. Date: Oct. 2, 2025

(54) IMAGING MODULE AND IMAGING DEVICE

(71) Applicant: Japan Display Inc., Tokyo (JP)

(72) Inventors: Hirondo NAKATOGAWA, Tokyo (JP); Yoshiro AOKI, Tokyo (JP); Hitoshi TANAKA, Tokyo (JP)

(21) Appl. No.: 19/076,065

(22) Filed: Mar. 11, 2025

(30) Foreign Application Priority Data
Mar. 27, 2024 (JP) 2024-050602

(51) Int. Cl. G03B 35/02

(52) U.S. Cl. CPC G03B 35/02

(57) ABSTRACT

The liquid crystal panel forms a geometric pattern by controlling the voltage applied to the electrodes. The panel surface has a shape of regular N-sided polygon (N ≥4). The geometric pattern includes a first aperture pattern and a second aperture pattern that can be used for stereo imaging. The first aperture is formed in one of the two regions on the panel surface that are spaced apart from each other by a distance greater than the diameter of a circular region, so as to interpose the specific circular region therebetween. The circular region has a center on the central axis of the cylindrical member and has the following diameter φ1. φ1=√2×r−2×d, where r: the radius of the inside of cylinder, d: the shortest distance from an end side of the array substrate to a circular electrode corresponding to the above circular area from a manufacturing design perspective.

### CROSS REFERENCES TO RELATED APPLICATIONS

The present application claims priority to Japanese Patent Application No. 2024-050602 filed on Mar. 27, 2024, the disclosure of which is incorporated herein by reference.

### BACKGROUND

The present disclosure relates to an imaging module and an imaging device.

In the field of coded imaging, a technique called Depth From Defocus (DFD) is known. The DFD technique is a technique that estimates a distance from an optical system of an imaging device to a subject, that is, the depth or the three-dimensional position of the subject, based on the degree of blur of edges visible in an image obtained by imaging.

The DFD technique is described, for example, in “Coded Aperture Pairs for Depth from Defocus and Defocus Deblurring” C. Zhou, S. Lin and S. K. Nayar, International Journal of Computer Vision, Vol. 93, No. 1, pp. 53, May. 2011. (Non-Patent Document 1). In DFD technology, coded imaging is performed by placing a mask called a coded aperture in a light entry area of the optical system to image the subject. Next, a decoding process based on the point spread function unique to the mask is applied to an imaged image obtained by coded imaging, and the three-dimensional position of the subject is estimated. The point spread function is generally referred to as PSF and is also known as the blur function, the blur spread function, or the point image distribution function.

The DFD technique is still in its developmental stage, and there is much room for improvement in its practicality. Similarly, there still is room for improvement in the practicality of an imaging device used for coded imaging or an imaging module that configures the imaging device.

The object of the present disclosure is to provide an imaging module and an imaging device with improved practicality.

### SUMMARY

A summary of the representative disclosure disclosed in the present application is as follows.

According to a representative embodiment of the present disclosure, an imaging module includes a lens, a liquid crystal panel having a panel surface perpendicular to an optical axis of the lens, a cylindrical member having a cylindrical shape and supporting the lens and the liquid crystal panel in an inside of cylinder, liquid crystal panel includes an array substrate, a counter substrate, an array substrate side electrode, an array substrate side alignment film, a counter substrate side electrode, a counter substrate side alignment film, liquid crystal present between the array substrate and the counter substrate, and a seal provided between the array substrate and the counter substrate and sealing the liquid crystal, and forms a specified geometric pattern under control of a voltage applied to the array substrate side electrode and the counter substrate side electrode, wherein the panel surface has a shape of regular N-sided polygon, where N is a natural number equal to or greater than 4, wherein the geometric pattern includes a pattern in which a first aperture, which is a light passing region, is formed, and a pattern in which a second aperture, which is a light passing region, is formed, wherein the first aperture is formed in one of two regions on the panel surface that are spaced apart from each other by a distance greater than a diameter of a specific circular region, so as to interpose the specific circular region therebetween, wherein the second aperture is formed in an other of the two regions, wherein the specific circular region has a center on a central axis in the inside of cylinder and has a diameter φ1 expressed by a following formula.

$$φ 1 = √ 2 \times r - 2 \times d$$

√2: a positive square root of 2,
r: a radius of the inside of cylinder,
d: in a case where the seal is disposed in a region of the counter substrate, an alignment film is disposed inside a frame formed by the seal, a circular electrode is disposed in a region of the alignment film, and a flexible printed circuit board connected both the array substrate side electrode and the counter substrate side electrode is disposed at an one end side portion of the array substrate, a shortest possible distance, from a manufacturing design perspective, from an end side of the one end side portion to the circular electrode in a direction parallel to the panel surface.

According to a representative embodiment of the present disclosure, an imaging device includes an imaging module, and an arithmetic and control unit, wherein the imaging module includes a lens, a liquid crystal panel having a panel surface perpendicular to an optical axis of the lens, a cylindrical member having a cylindrical shape and supporting the lens and the liquid crystal panel in an inside of cylinder, and an imaging element that receives light from a subject that has passed through the lens and the liquid crystal panel, the liquid crystal panel includes an array substrate, a counter substrate, an array substrate side electrode, an array substrate side alignment film, a counter substrate side electrode, a counter substrate side alignment film, liquid crystal present between the array substrate and the counter substrate, and a seal provided between the array substrate and the counter substrate and sealing the liquid crystal, and forms a specified geometric pattern under control of a voltage applied to the array substrate side electrode and the counter substrate side electrode, wherein the panel surface has a shape of regular N-sided polygon, where N is a natural number equal to or greater than 4, wherein the geometric pattern includes a pattern in which a first aperture, which is a light passing region, is formed, and a pattern in which a second aperture, which is a light passing region, is formed, wherein the first aperture is formed in one of two regions on the panel surface that are spaced apart from each other by a distance greater than a diameter of a specific circular region, so as to interpose the specific circular region therebetween, wherein the second aperture is formed in an other of the two regions, wherein the specific circular region has a center on a central axis in the inside of cylinder and has a diameter φ1 expressed by a following formula.

$$φ 1 = √ 2 \times r - 2 \times d$$

√2: a positive square root of 2,
r: a radius of the inside of cylinder,
d: in a case where the seal is disposed in a region of the counter substrate, an alignment film is disposed inside a frame formed by the seal, a circular electrode is disposed in a region of the alignment film, and a flexible printed circuit board connected to both the array substrate side electrode and the counter substrate side electrode is disposed at an one end side portion of the array substrate, a shortest possible distance, from a manufacturing design perspective, from an end side of the one end side portion to the circular electrode in a direction parallel to the panel surface, and
wherein the arithmetic and control unit controls the imaging module and the imaging element so that stereo imaging using the first aperture and the second aperture is performed, and calculates an estimation value of three-dimensional position of the subject based on an imaged image acquired by the stereo imaging.

### BRIEF DESCRIPTION OF THE DRAWINGS

FIG. 1 is a diagram illustrating a configuration example of a reference imaging module.

FIG. 2 is a diagram illustrating a configuration example of a liquid crystal panel in the reference imaging module.

FIG. 3 is a diagram illustrating a configuration example of the liquid crystal panel in the reference imaging module.

FIG. 4 is a diagram illustrating an internal configuration example of a cylindrical member in the reference imaging module.

FIG. 5 is a diagram illustrating a main part configuration example of the liquid crystal panel in the reference imaging module.

FIG. 6 is a diagram illustrating a configuration example of an imaging module according to a first embodiment.

FIG. 7 is a front configuration diagram of a liquid crystal panel according to the first embodiment.

FIG. 8 is a cross-sectional view of the liquid crystal panel according to the first embodiment.

FIG. 9 is a diagram illustrating an internal configuration example of a cylindrical member in the imaging module according to the first embodiment.

FIG. 10 is a diagram illustrating a main part configuration example of the liquid crystal panel according to the first embodiment.

FIG. 11 is a diagram illustrating a configuration example of a liquid crystal panel according to a first modification.

FIG. 12 is a diagram illustrating a configuration example of a liquid crystal panel according to a second modification.

FIG. 13 is a diagram illustrating a configuration example of a liquid crystal panel according to a third modification.

FIG. 14 is a diagram illustrating a configuration example of a liquid crystal panel according to a fourth modification.

FIG. 15 is a diagram illustrating a configuration example of an imaging module according to a second embodiment.

FIG. 16 is a front configuration diagram of a liquid crystal panel according to the second embodiment.

FIG. 17 is a cross-sectional view of the liquid crystal panel according to the first embodiment.

FIG. 18 is a diagram illustrating an internal configuration example of a cylindrical member in the imaging module according to the second embodiment.

FIG. 19 is a diagram illustrating a main part configuration example of the liquid crystal panel according to the second embodiment.

FIG. 20 is a diagram illustrating a configuration example of an imaging device according to a third embodiment.

FIG. 21 is a diagram illustrating a configuration example of an arithmetic and control unit according to the third embodiment.

FIG. 22 is a diagram illustrating an application example of the imaging device according to the third embodiment.

### DETAILED DESCRIPTION

### Background of Examination Conducted by Present Inventors

Before describing the embodiments of the present disclosure, the background of the examination conducted by the present inventors will be described.

The blur characteristics of a subject in an imaged image generally depend on the point spread function, which is determined by factors such as an optical system of an imaging device, the shape of a light entry area of the optical system. When a mask is placed in the light entry area of the optical system, forming a coded aperture that partially blocks the light, the point spread function depends on a geometric pattern of the mask. Imagining a subject with an imaging device in which the mask is installed is referred to as coded imaging. When the subject is imaged using coded imaging, a blurred image based on the point spread function unique to the mask used is obtained as an imaged image.

When the decoding process is applied to the imaged image being a blurred image, a decoded image with reduced blur and information of three-dimensional position of the object corresponding to each position of the subject included in the decoded image are acquired. The decoding process here refers to a process of performing deconvolution based on the point spread function unique to the mask used.

Meanwhile, the present inventors have been examining an imaging device capable of acquiring an imaged image required for estimating the three-dimensional position (depth) of a subject. The present inventors are examining a configuration in which a lens and a liquid crystal panel are supported inside a cylindrical member as an imaging module that configures the imaging device. The liquid crystal panel can function as a coded aperture or the like depending on the geometric pattern formed. The present inventors have confirmed that when adopting such an imaging module, there various from are constraints a manufacturing design perspective. The following provides a detailed description of the configuration of the reference imaging module and the constraints thereof from a manufacturing design perspective.

### Configuration Example of Reference Imaging Module

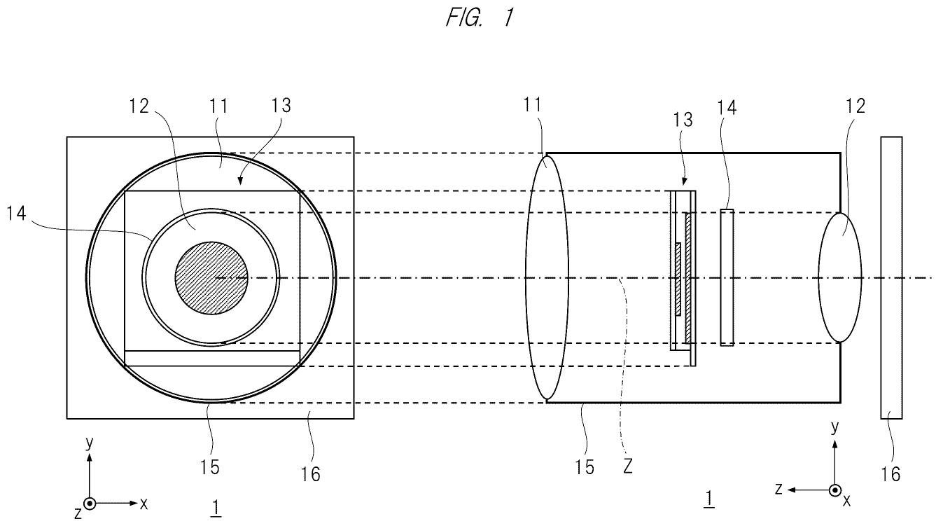

FIG. 1 is a diagram illustrating a configuration example of a reference imaging module. The configuration example of a reference imaging module 1 illustrated in FIG. 1 is a configuration example that is considered to be general as a configuration in which a liquid crystal panel is applied to form a coded aperture in the imaging module 1. The left diagram in FIG. 1 is a front configuration diagram of the reference imaging module, illustrating a schematic configuration example of the module when viewed in an optical axis direction. The right diagram in FIG. 1 is a side configuration diagram of the reference imaging module, illustrating a schematic configuration example of the module when viewed in a direction perpendicular to the optical axis.

As illustrated in FIG. 1, the imaging module 1 includes a first lens 11, a second lens 12, a liquid crystal panel 13, an aperture mechanism 14, a cylindrical member 15, and an imaging element 16.

The first lens 11 is disposed on the subject side and collects light emitted or reflected from the subject. The second lens 12 is disposed on an optical axis Z of the first lens 11 on the side opposite to the subject side. The liquid crystal panel 13 is disposed between the first lens 11 and the second lens 12. The liquid crystal panel 13 is controlled from the outside to form a specified aperture pattern. When coded imaging is performed, the liquid crystal panel 13 forms a coded aperture.

The aperture mechanism 14 is controlled from the outside and changes the aperture value, that is, the size of the aperture, so that imaging is performed at a set exposure level. The cylindrical member 15 has a cylindrical shape, and supports the first lens 11, the second lens 12, the liquid crystal panel 13, and the aperture mechanism 14 inside the cylinder. The cylindrical member 15 is also referred to as a lens barrel. The imaging element 16 is disposed on the optical axis Z of the first lens 11 and the second lens 12, receives light that has passed through the first lens 11 and the second lens 12 on a light receiving surface thereof, and performs photoelectric conversion, and outputs data of the imaged image. The imaging element 16 is also referred to as an image sensor.

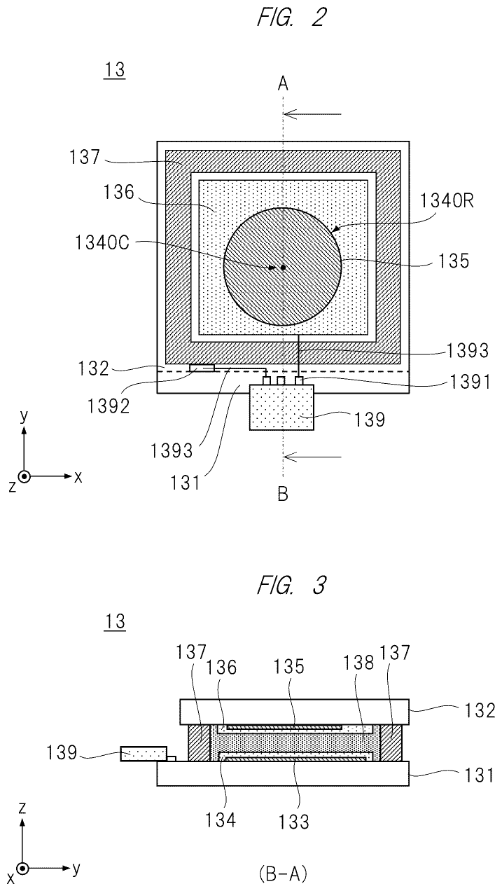

FIGS. 2 and 3 are diagrams illustrating a configuration example a liquid crystal panel in a reference imaging module. FIG. 2 is a front configuration diagram of the liquid crystal panel 13, illustrating a configuration example of the panel when viewed in the optical axis direction. FIG. 3 is a side configuration diagram of the liquid crystal panel 13, illustrating a cross section taken along line A-B of the liquid crystal panel 13 in FIG. 2. As illustrated in FIGS. 2 and 3, the liquid crystal panel 13 includes an array substrate 131, a counter substrate 132, an array substrate side electrode 133, an array substrate side alignment film 134, a counter substrate side electrode 135, a counter substrate side alignment film 136, a seal 137, liquid crystal 138, and a flexible printed circuit board (FPC) 139.

The array substrate 131 is a glass substrate provided with an electric circuit function for driving the liquid crystal 138. The counter substrate 132 is a glass substrate facing the array substrate 131. The seal 137 is disposed between the array substrate 131 and the counter substrate 132 in close contact with each other, and has a frame-like shape that surrounds a certain region. The array substrate side electrode 133 is disposed on a substrate surface of the array substrate 131 facing the counter substrate 132. The counter substrate side electrode 135 is disposed on a substrate surface of the counter substrate 132 facing the array substrate 131. The array substrate side electrode 133 is disposed on a surface located inside the seal 137 on the array substrate 131 side. The counter substrate side electrode 135 is disposed on a surface located inside the seal 137 on the counter substrate 132 side. The array substrate side electrode 133 and the counter substrate side electrode 135 are so-called transparent electrodes that transmit light.

The array substrate side electrode 133 disposed on the array substrate 131 side is, for example, configured as a single electrode that extends over a region corresponding to the counter substrate side electrode 135 or over a region wider than that. On the other hand, the counter substrate side electrode 135 disposed on the counter substrate 132 side is, for example, configured by dividing a circular electrode into a plurality of partial electrodes. The positional relationship between the array substrate side electrode 133 and the counter substrate side electrode 135 may be reversed.

The array substrate 131 and the counter substrate 132 generally have rectangular plate surfaces. This is because the method of cutting a single large transparent substrate into a lattice pattern to produce a plurality of substrates is efficient and particularly common. In other words, it can be said that substrates having a plate surface other than rectangular are not common because the cutting process takes time and effort. In the liquid crystal panel 13 in the reference imaging module 1, the array substrate 131 has a square substrate surface, and the counter substrate 132 has a rectangular substrate surface that is slightly shorter than the array substrate 131.

The flexible printed circuit board 139 is provided on a side of the one end side of the array substrate 131. A plurality of outer lead bonding (OLB) pads 1391 is provided in the array substrate 131 in the vicinity of the flexible printed circuit board 139 and each of which is electrically connected to the flexible printed circuit board 139. Some of the OLB pads 1391 are connected to the array substrate side electrodes 133 via signal lines 1393. Also, a transfer pad 1392 is provided on the counter substrate 132. Some of the OLB pads 1391 and each partial electrode of the counter substrate side electrode 135 are connected via the transfer pads 1392 and the signal lines 1393. Therefore, the voltages applied to the array substrate side electrode 133 and the counter substrate side electrode 135 can be controlled by a circuit connected via the flexible printed circuit board 139.

Whether a predetermined voltage is applied between each of the plurality of electrodes comprising the array substrate side electrode 133 and the counter substrate side electrode 135 is controlled. By controlling the voltage applied to such electrodes, the region corresponding to each partial electrode can be switched between a light blocking region and a light passing region, forming an aperture of a specified geometric pattern.

The array substrate side alignment film 134 is disposed so as to cover the array substrate side electrode 133 disposed on the array substrate 131. The counter substrate side alignment film 136 is disposed so as to cover the counter substrate side electrode 135 disposed on the counter substrate 132. These alignment films are made of, for example, polyimide.

The liquid crystal 138 is filled in a space surrounded by the array substrate side alignment 134, the counter substrate side alignment film 136, and the seal 137.

### Problems Found by Present Inventors

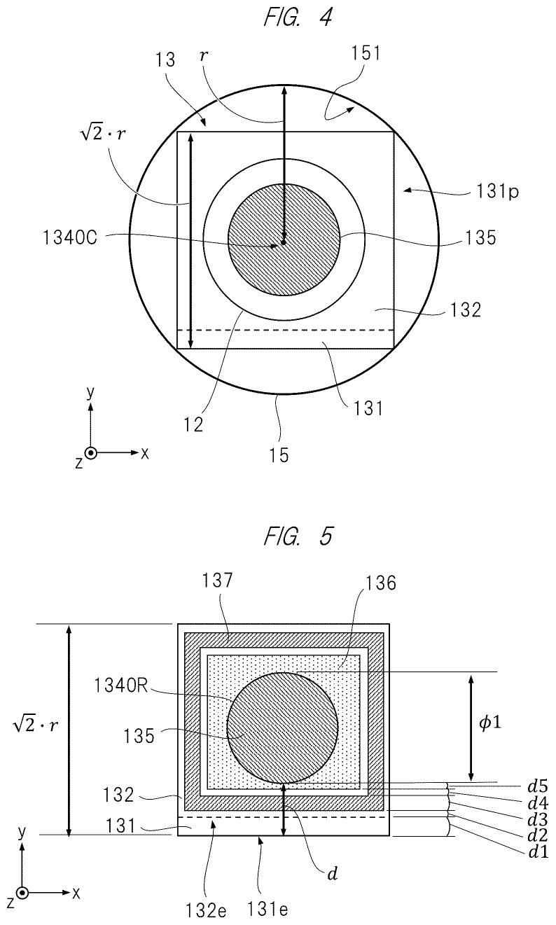

FIG. 4 is a diagram illustrating an internal configuration example of the cylindrical member in the reference imaging module. FIG. 5 is a diagram illustrating a main part configuration example of the liquid crystal panel in the reference imaging module.

As illustrated in FIG. 4, a panel surface 131p of the liquid crystal panel 13 is disposed so as to be inscribed on the cylindrical inner surface 151 of the cylindrical member 15. Also, as illustrated in FIG. 5, when the liquid crystal panel 13 is viewed in the optical axis direction (the direction along the z direction), it can be seen that an one end side 132e of the counter substrate 132 is located inside an one end side 131e of the array substrate 131, and the seal 137 is located inside the one end side 132e of the counter substrate 132. It can also be seen that the counter substrate side alignment film 136 is located inside the seal 137, and further the counter substrate side electrode 135 is located inside the counter substrate side alignment film 136.

Here, it is assumed that the liquid crystal panel 13 is disposed so as to be inscribed on the cylindrical inner surface of the cylindrical member 15. It is also assumed that the array substrate 131 has a square shape, and the counter substrate side electrode 135 has a circular shape. The reason for the circular counter substrate side electrode 135 is to prevent uneven density from occurring in the aperture pattern formed in the liquid crystal panel 13. Normally, in the liquid crystal panel 13, a plurality of spacers is provided between the array substrate 131 and the counter substrate 132 to equalize the distance between the substrates and suppress uneven density of the geometric pattern to be formed. However, if the counter substrate side electrode 135 is polygonal or elliptical, it becomes difficult to disposed spacers around the electrode at equal intervals in the substrate surface direction, and the above-mentioned uneven density becomes likely to occur.

When the liquid crystal panel 13 is viewed in the optical axis direction (direction along the y direction), the diameter φ1 of the counter substrate side electrode 135 can be expressed by the following equation (1), in which, r represents the inner radius of the cylindrical member 15, and d represents the shortest distance from the one end side 131e of the array substrate 131 to the end of the counter substrate side electrode 135.

$$\begin{matrix}( Expression 1 ) & \\ \begin{matrix}ϕ1 = \sqrt{2} \cdot r - 2 d \\ \dot{{=}_{.}} 1.41 \cdot r - 2 d\end{matrix} & ( 1 )\end{matrix}$$

As illustrated in FIG. 5, the shortest distance d from the one end side 131e of the array substrate 131 to the counter substrate side electrode 135 is expressed as the sum of distances d1 to d5.

The distance d1 is the minimum distance necessary from the one end side 131e of the array substrate 131 on the side where the flexible printed circuit board is arranged to the one end side 132e of the counter substrate 132 on the same side, and corresponds to the width of the mounting portion of the flexible printed circuit board. The distance d2 is the minimum distance necessary from the one end side 132e of the counter substrate 132 to the end of the seal 137. The distance d3 is the minimum distance necessary width of the seal 137, that is, the minimum distance necessary as the width of the frame band formed by the seal 137. The distance d4 is the minimum distance necessary from the end of the seal 137 to the end of the counter substrate side alignment film 136. The distance d5 is the minimum distance necessary from the end of the counter substrate side alignment film 136 to the end of a specific circular region 1340R.

As described above, the minimum values of the distances d1 to d5 are determined by a condition from the manufacturing design of the liquid crystal panel 13. Therefore, assuming that the distance d, which is the sum of distances d1 to d5, takes its minimum value, it can be considered as an almost constant value as long as the manufacturing environment of the liquid crystal panel remains the same.

As described above, there is a limit to how much the distance d from the end of the array substrate 131 to the counter substrate side electrode 135 can be reduced. The inner radius r of the cylindrical member 15 is determined by the size of the cylindrical member 15. Therefore, even if a larger diameter φ1 is desired for the counter substrate side electrode 135 relative to the cylindrical member 15, it cannot be increased because the substrate surface of the array substrate 131 is rectangular, and the panel surface 131p of the liquid crystal panel 13 is also rectangular. That is, in the imaging module 1, the size of the counter substrate side electrode 135 of the liquid crystal panel 13 cannot be made sufficiently large relative to the cross-sectional area of the cylindrical member 15.

Besides using coded imaging, another method for estimating the three-dimensional position (depth) of the subject is to use stereo imaging. In the method using the stereo imaging, the same subject is typically imaged using two imaging devices positioned differently. The three-dimensional position of the subject is then estimated using triangulation, based on the parallax between the two imaged images. On the other hand, considering the principle of stereo imaging, two imaging devices are not necessarily required to acquire two imaged images of the subject with parallax. In other words, even with a single imaging device, it is possible to acquire two types of imaged images of the subject with parallax by using two different apertures positioned at different locations.

Therefore, for example, in the liquid crystal panel 13, a first electrode corresponding to a first aperture and a second electrode corresponding to a second aperture are introduced, so that the first aperture pattern and the second aperture pattern are formed. Then, the three-dimensional position of the subject may be estimated using an imaged image acquired when the first aperture pattern is formed and an imaged image acquired when the second aperture pattern is formed. In this case, it is natural to form the electrodes corresponding to those apertures within the range of the circular region corresponding to the counter substrate side electrode 135.

However, if the regions of these two types of apertures are limited within the range of the circular region corresponding to the counter substrate side electrode 135, the baseline length, which is the distance between the apertures of these two types, becomes constrained, and the parallax of the subject in the imaged image cannot be increased. If the parallax is not large, there is a problem in that when estimating the three-dimensional position (depth) of the subject based on the imaged mage, the estimation error becomes large, which impairs practicality.

In view of the above circumstances, the present inventors conducted extensive examination and devised the present disclosure. Hereinafter, embodiments of the present disclosure will be described. The embodiments described below are examples for implementing the present disclosure, and do not limit the technical scope of the present disclosure. In the following embodiments, components having the same functions are denoted by the same reference numerals, and repeated descriptions thereof will be omitted unless otherwise necessary.

### First Embodiment

### Overview of Imaging Module According to First Embodiment

An imaging module according to a first embodiment will be described. In the imaging module according to the first embodiment, a panel surface of a liquid crystal panel has a rectangular shape. Geometric patterns formed on the liquid crystal panel include a pattern in which a first aperture is formed and a pattern in which a second aperture is formed.

The first aperture is formed in one of the two regions on the panel surface that are spaced apart from each other by a distance greater than the diameter of a specific circular region, so as to interpose the specific circular region therebetween. The second aperture is formed in the other of the two regions mentioned above.

The specific circular region has its center on the central axis inside the cylinder of a cylindrical member that supports a lens and the liquid crystal panel, and has a substantially perfect circular shape. The specific circular region has a diameter such that the distance from an one end side of the array substrate, where the flexible printed circuit board is deposited, to the specific circular region is the shortest possible from the manufacturing design perspective.

The first aperture and the second aperture function as an aperture of an imaging system and are used for so-called stereo imaging. The two parallax imaged images obtained through stereo imaging are used to estimate the depth of the subject using triangulation.

### Configuration of Imaging Module According to First Embodiment

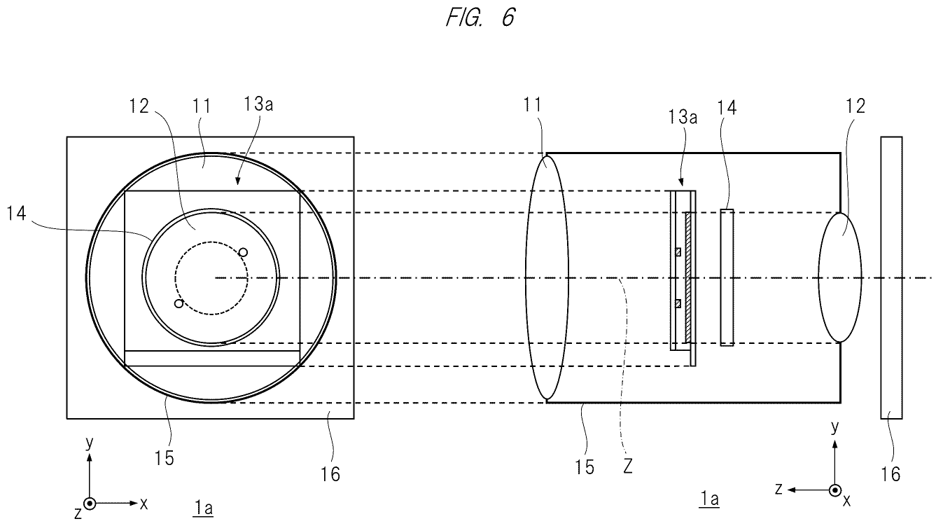

FIG. 6 is a diagram illustrating a configuration example of an imaging module according to the first embodiment. In FIG. 6, to facilitate understanding of the structure of the imaging module, components that are not directly visible from the outside are also depicted with solid lines. As illustrated in FIG. 6, an imaging module 1a according to the first embodiment includes a first lens 11, a second lens 12, a liquid crystal panel 13a, an aperture mechanism 14, a cylindrical member 15, and an imaging element 16. The imaging element 16 may be separated from the imaging module 1a. The first lens 11 or the second lens 12 may be omitted as necessary. Further, when the liquid crystal panel 13a has an aperture function, the aperture mechanism 14 may be omitted as necessary.

As illustrated in FIG. 6, in the present specification, for convenience, an x direction, a y direction, and a z direction that are orthogonal to each other are defined in a space in which the imaging module 1a is installed. The x direction is the horizontal width direction of the liquid crystal panel 13a. The y direction is the vertical width direction of the liquid crystal panel 13a, that is, the height direction. The z direction is a direction perpendicular to the panel surface of the liquid crystal panel 13a and parallel to the central axis of the cylindrical member 15.

The first lens 11 and the second lens 12 collect light from a subject and form an image of the subject on a light receiving surface of the imaging element 16. The cylindrical member 15 has a cylindrical shape, and supports the first lens 11, the second lens 12, the liquid crystal panel 13a, and the aperture mechanism 14 inside the cylinder. The panel surface of the liquid crystal panel 13 a is perpendicular to the optical axis Z of the first lens 11 and the second lens 12.

### Configuration Example of Liquid Crystal Panel According to First Embodiment

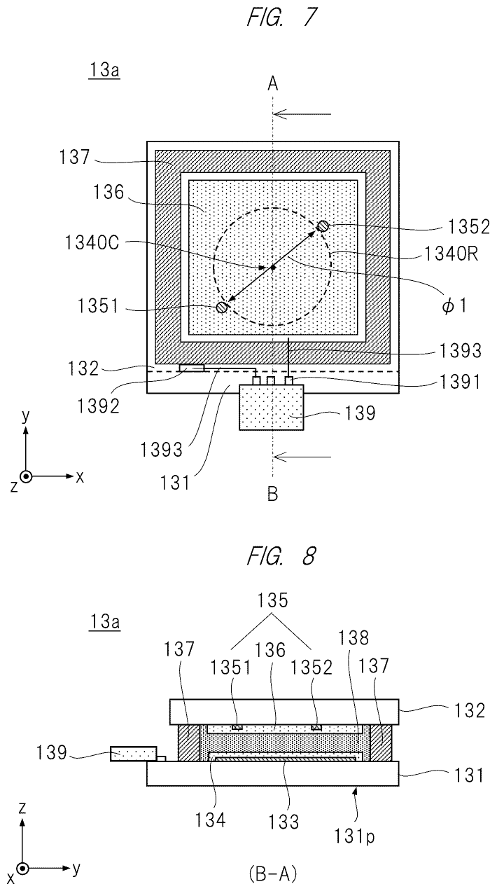

FIG. 7 is a front configuration diagram of the liquid crystal panel according to the first embodiment. FIG. 8 is a cross-sectional view of the liquid crystal panel according to the first embodiment. FIG. 7 is a diagram illustrating the liquid crystal panel 13a when viewed in the z direction parallel to the optical axis direction. FIG. 8 is a cross-sectional view illustrating the liquid crystal panel 13a illustrated in FIG. 7 taken along line A-B when viewed in the x direction.

As illustrated in FIGS. 7 and 8, the liquid crystal panel 13a includes an array substrate 131, a counter substrate 132, an array substrate side electrode 133, an array substrate side alignment film 134, a counter substrate side electrode 135, a counter substrate side alignment film 136, a seal 137, and liquid crystal 138.

The array substrate 131 has a flat substrate surface corresponding to the panel surface 131p of the liquid crystal panel 13a. The panel surface 131p of the array substrate 131 has a square (regular quadrilateral) shape when viewed in the z direction. It is assumed that the array substrate 131 is obtained, for example, by mechanically dicing a single semiconductor substrate. Also, it is assumed that the liquid crystal panel 13 a is disposed so that the array substrate 131, which is a component thereof, is inscribed on the cylindrical member 15. Therefore, it is a preferable example that the array substrate 131 has a square shape.

The counter substrate 132 is disposed so as to face the array substrate 131. The flexible printed circuit board 139 is disposed in a region in the vicinity of an one end side in the substrate surface of the array substrate 131 facing the counter substrate 132. Here, it is assumed that the flexible printed circuit board 139 is mounted in a region in the vicinity of an end edge located on the lower side in the y direction. Here, the side of the array substrate 131 on which the flexible printed circuit board 139 is disposed is referred to as a first side.

The substrate surface of the counter substrate 132 has a rectangular shape when viewed in the z direction. Specifically, the substrate surface of the counter substrate 132 has a shape obtained by cutting out a rectangular portion from the square substrate surface of the array substrate 131, the rectangular portion including the region where the flexible printed circuit board 139, which is a region on the first side, is disposed.

The array substrate side electrode 133 is disposed on the substrate surface of the array substrate 131 facing the counter substrate 132. The array substrate side electrode 133 is a so-called transparent substrate that has light transmissibility. Further, the array substrate side alignment film 134 is disposed so as to cover the array substrate side electrode 133. The counter substrate side electrode 135 is disposed on the substrate surface of the counter substrate 132 facing the array substrate 131. The counter substrate side electrode 135 is a so-called transparent that substrate has light transmissibility. Further, the counter substrate side alignment film 136 is disposed so as to cover the counter substrate side electrode 135. The array substrate side alignment film 134 and the counter substrate side alignment film 136 have substantially the same rectangular shape.

Between the array substrate 131 and the counter substrate 132, the rectangular frame-shaped seal 137 is disposed so as to enclose the array substrate side alignment film 134 and the counter substrate side alignment film 136. Also, the liquid crystal 138 is present between the array substrate 131 and the counter substrate 132 and is sealed in by the seal 137.

The flexible printed circuit board 139 is connected to the array substrate side electrode 133 and the counter substrate side electrode 135 via an OLB pad 1391, a transfer pad 1392, a signal line 1393, and the like. At least one of the array substrate side electrode 133 and the counter substrate side electrode 135 is configured of a plurality of electrodes.

Here, it is assumed that the array substrate side electrode 133 is configured of a single electrode, and the counter substrate side electrode 135 is configured of a first electrode 1351 and a second electrode 1352. Also, the first electrode 1351 and the second electrode 1352 have the same size and shape. The first electrode 1351 and the second electrode 1352 have a shape that is a perfect circle when viewed from the z direction.

The first electrode 1351 and the second electrode 1352 may also have an elliptical or polygonal shape. Further, the first electrode 1351 and the second electrode 1352 may have different sizes and shapes. Further, in addition to the array substrate electrode 133, a light blocking member may be disposed on the array substrate 131.

A voltage is applied from the outside to each of the electrodes configuring the array substrate side electrode 133 and the counter substrate side electrode 135 via the flexible printed circuit board 139. Also, by controlling the voltage applied to these electrodes, various geometric patterns are formed on the panel surface 131p.

The geometric pattern is a pattern that combines the light passing region and the light blocking region. The geometric pattern includes a first aperture pattern and a second aperture pattern. The first aperture pattern is a pattern in which only the region corresponding to the first electrode 1351 on the panel surface 131p becomes a light passing region. The second aperture pattern is a pattern in which only the region corresponding to the second electrode 1352 on the panel surface 131p becomes a light passing region. That is, in the first aperture pattern, the region corresponding to the first electrode 1351 becomes the first aperture which is a light passing region. In the second aperture pattern, the region corresponding to the second electrode 1352 becomes the second aperture which is a light passing region.

The first aperture is formed in one of two regions on the panel surface 131p that are spaced apart from each other by a distance greater than the diameter 1 of the specific circular region 1340R, so as to interpose the specific circular region 1340R therebetween. The second aperture is formed in the other of the two regions mentioned above.

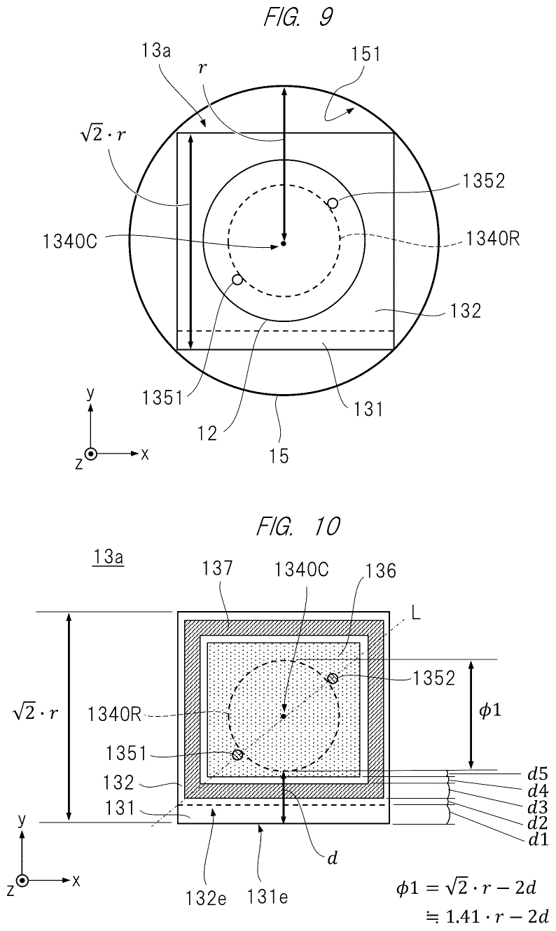

FIG. 9 is a diagram illustrating the internal configuration example of the cylindrical member in the imaging module according to the first embodiment. FIG. 10 is a diagram illustrating a main part configuration example of the liquid crystal panel according to the first embodiment.

As illustrated in FIGS. 9 and 10, the specific circular region 1340R has a center 1340C on the central axis inside the cylindrical member 15, and has a diameter φ1 expressed by the following expression.

$$\begin{matrix}( Expression 2 ) & \\ \begin{matrix}ϕ1 = \sqrt{2} \cdot r - 2 d \\ \dot{{=}_{.}} 1.41 \cdot r - 2 d\end{matrix} & ( 2 )\end{matrix}$$

Here, r represents the inner cylindrical radius of the cylindrical member 15. d represents a distance from the one end side 131e of an one end side portion in a direction parallel to the panel surface 131p to the circular electrode, which is the shortest distance in terms of manufacturing design, under the condition where the seal 137 is disposed within the region of the counter substrate 132, the counter substrate side alignment film 136 is disposed inside the frame formed by the seal 137, a circular electrode corresponding to the specific circular region 1340R is disposed within the region of the counter substrate side alignment film 136, and a flexible printed circuit board 139 connected to a plurality of electrodes is mounted on the one end side portion of a plurality of end side portions of the array substrate 131.

As illustrated in FIG. 10, the distance d is the sum of the distance d1, the distance d2, the distance d3, the distance d4, and the distance d5 in the direction parallel to the panel surface 131p. The distances d1 to d5 are each considered the minimum distances necessary required in manufacturing and designing the liquid crystal panel 13a.

The distance d1 is the minimum distance necessary from the one end side 131e on the first side of the array substrate 131 on which the flexible printed circuit board 139 is disposed to the one end side 132e on the same side of the counter substrate 132, and corresponds to the width of the mounting portion of the flexible printed circuit board 139. The distance d2 is the minimum distance necessary from the one end side 132e of the counter substrate 132 to the end of the seal 137. The distance d3 is the minimum distance necessary of the seal 137, that is, the minimum distance necessary as the width of the frame band formed by the seal 137. The distance d4 is the minimum distance necessary from the end of the seal 137 to the end of the counter substrate side alignment film 136. The distance d5 is the minimum distance necessary from the end of the counter substrate side alignment film 136 to the end of the specific circular region 1340R.

The distance d1 is, for example, 3 mm. The distance d2 is, for example, 1 mm. The distance d3 is, for example, 3 mm. The distance d4 is, for example, 1 mm. The distance d5 is, for example, 1 mm. In this case, the distance d is 9 mm. If the inner cylindrical radius r of the cylinder is, 15 mm, the diameter § 1 of the particular circular region 1340R can be calculated as follows:

$$\begin{matrix}[ Expression 3 ] & \\ \begin{matrix}ϕ1 = \sqrt{2} \cdot r - 2 d \\ \dot{{=}_{.}} 1.41 \times 15 - 2 \times 9 \\ = 21.15 - 18 \\ = 3.15 [ mm ]\end{matrix} & ( 3 )\end{matrix}$$

When forming two apertures for stereo imaging using the liquid crystal panel, the two apertures are formed by controlling the voltage applied to the plurality of electrodes. In this case, it is generally assumed that the plurality of electrodes is provided within the range of the above-mentioned specific circular region. This is because, when forming a coded aperture using the liquid crystal panel, it is natural to provide the plurality of electrodes within the range of the above-mentioned specific circular region.

On the other hand, in stereo imaging, the longer the baseline length, which is the distance between the first aperture and the second aperture, the greater the parallax of the subject in the imaged image, making it possible to acquire a more accurate estimation value of three-dimensional position (depth) of the subject.

According to the first embodiment, the first aperture is disposed in one of two regions that are spaced apart from each other by a distance greater than the diameter of the above-mentioned specific circular region, and the second aperture is disposed in the other of the two regions so as to interpose the above-mentioned circular region therebetween. Therefore, the baseline length between the first aperture and the second aperture can be made longer than the length normally assumed, making it possible to acquire the more accurate estimation value of three-dimensional position (depth) of the subject. In other words, according to the first embodiment, it is possible to provide an imaging module with improved practicality.

### First Modification

FIG. 11 is a diagram illustrating a configuration example of a liquid crystal panel according to a first modification. As illustrated in FIG. 11, in a liquid crystal panel 13b according to the first modification, the centers or the centroids of the first electrode 1351 and the second electrode 1352 are positioned on a straight line L. The straight line L is, for example, a straight line passing through the center 1340C of the specific circular region 1340R and points corresponding to the corners of a rectangle formed by the periphery of the substrate surface of the array substrate 131. Also, the straight line L is, for example, a straight line passing through the center 1340C of the specific circular region 1340R and points corresponding to the corners of a rectangle formed by the periphery of the substrate surface of the counter substrate 132. Further, the straight line L is, for example, a straight line corresponding to a diagonal line of a rectangle formed by the substrate surface of the array substrate 131. Further, the straight line L is, for example, a straight line corresponding to a diagonal line of a rectangle formed by the substrate surface of the counter substrate 132.

The first electrode 1351 and the second electrode 1352 are disposed so that the shortest distance from the periphery of the counter substrate side alignment film 136 is the distance d5 in the first embodiment. The first aperture is formed when the region corresponding to the first electrode 1351 becomes a light passing region. The second aperture is formed when the region corresponding to the second electrode 1352 becomes a light passing region.

According to the first modification, the baseline length, which is the distance between the first aperture and the second aperture, can be made longer, making it possible to acquire the more accurate estimation value of three-dimensional position (depth) of the subject.

### Second Modification

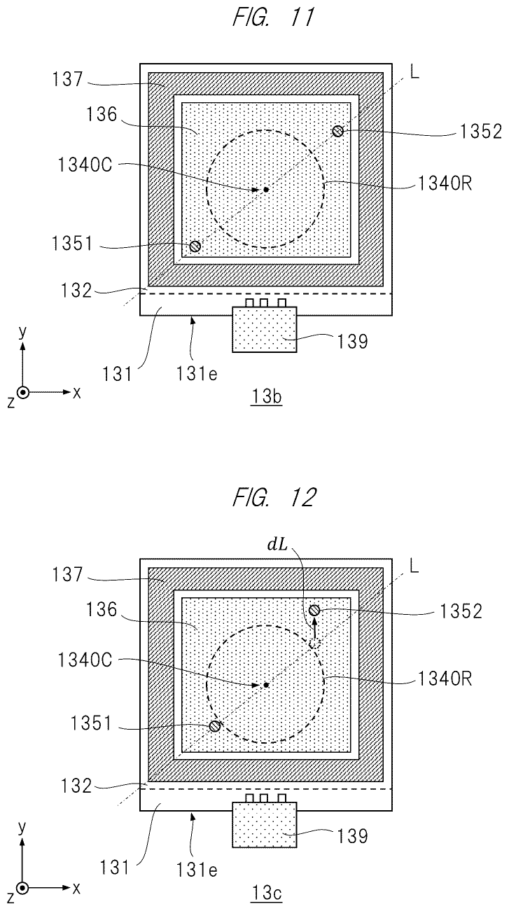

FIG. 12 is a diagram illustrating a configuration example of a liquid crystal panel according to a second modification. As illustrated in FIG. 12, in a liquid crystal panel 13c according to the second modification, the first electrode 1351 is disposed so that its center or centroid is positioned on a straight line L passing through a center 1340C of a specific circular region 1340R. A second electrode 1352 is disposed so that its center or centroid is positioned at a position shifted by a distance dL from the straight line L in a direction away from an one end side 131e of the array substrate 131 (here, upward in the y direction). The first aperture is formed when the region corresponding to the first electrode 1351 becomes a light passing region. The second aperture is formed when the region corresponding to the second electrode 1352 becomes a light passing region.

That is, of the first aperture and the second aperture, the aperture that is relatively closer to the one end side 131e of the one end side portion on the first side, where the flexible printed circuit board 139 is disposed (here, the first aperture corresponding to the first electrode 1351), has its center or centroid positioned on the straight line L passing through the center of the specific circular region 1340R. Also, of the first aperture and the second aperture, the aperture that is relatively farther away from the one end side 131e of the above-mentioned one end side portion (here, the second aperture corresponding to the second electrode 1352), has its center or centroid positioned at a position shifted by a distance dL from the straight line L in a direction away from the one end side 131e of the array substrate 131 (here, upward in the y direction).

On the substrate surface of the array substrate 131, there are no components to be mounted on the side opposite to the first side on which the flexible printed circuit board 139 is disposed, that is, on a portion on the side away from the one end side 131e. Therefore, in the region of the counter substrate side alignment film 136, in the region on the side away from the one end side 131e with respect to the straight line L, there is a vacant space. In order to effectively utilize the vacant space, it is conceivable to shift the second electrode 1352 forming the second aperture away from the straight line L in a direction away from the one end side 131e, as described above.

According to the second modification, the baseline length between the first aperture and the second aperture can be made longer, making it possible to acquire the more accurate estimation value of three-dimensional position (depth) of the subject.

### Third Modification

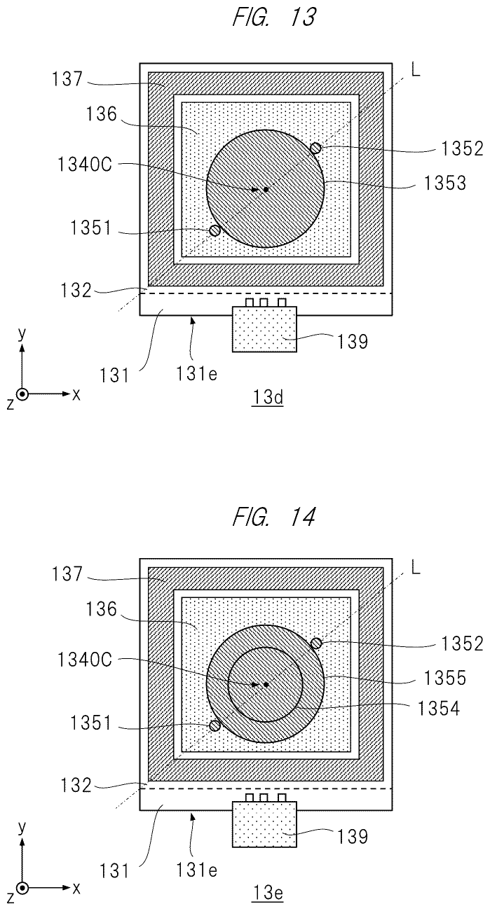

FIG. 13 is a diagram illustrating a configuration example of a liquid crystal panel according to a third modification. As illustrated in FIG. 13, in a liquid crystal panel 13d according to the third modification, the electrodes configuring the counter substrate side electrode 135 include a third electrode 1353, in addition to the first electrode 1351 and the second electrode 1352. The third electrode 1353 is disposed to overlap the particular circular region 1340R. When the third electrode 1353 becomes a light passing region, a third aperture corresponding to the third electrode 1353 is formed. That is, in the liquid crystal panel 13d, the geometric pattern formed includes, a third aperture pattern in which the third aperture corresponding to the specific circular region 1340R is formed, in addition to the first aperture pattern and the second aperture pattern.

The third electrode 1353 has a larger area compared with the first electrode 1351 and the second electrode 1352. In other words, the third aperture is a larger aperture than the first aperture or the second aperture. Of the light arriving from the subject, the amount of light passing through the third aperture is greater than that passing through the first aperture or the second aperture, and the amount of light received by the imaging element 16 increases. As a result, it is possible to shorten the exposure time and make the imaged image brighter, clearer when imaging a subject.

Therefore, for example, consider a case where a subject is stereo imaged using the first aperture and the second aperture, and separately, the subject is normally imaged using the third aperture. In this case, information about the three-dimensional position (depth) of the subject acquired by stereo imaging can be superimposed on the bright and clear imaged image acquired by normal imaging, thereby generating a more suitable depth map.

Also, for example, consider a case where a subject is normally imaged and stereo imaging is not performed. In this case, compared with performing normal imaging using the first aperture or the second aperture, it is possible to acquire a brighter and clearer imaged image.

According to the third modification, it is possible to acquire a more suitable normal image of the subject, or a more suitable depth map of the subject.

### Fourth Modification

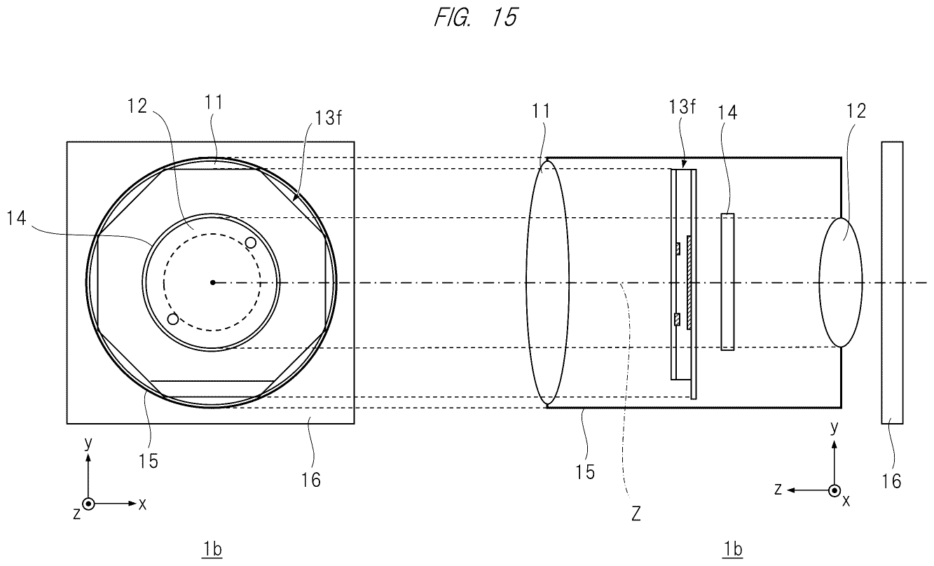

FIG. 14 is a diagram illustrating a configuration example of a liquid crystal panel according to a fourth modification. As illustrated in FIG. 14, in a liquid crystal panel 13e according to the fourth modification, the electrodes configuring the counter substrate side electrode 135 include a fourth electrode 1354 and a fifth electrode 1355, in addition to the first electrode 1351 and the second electrode 1352. The fourth electrode 1354 and the fifth electrode 1355 are obtained by dividing the third electrode 1353 in the third modification, along concentric circles defined by the edge of the specific circular region 1340R. The fourth electrode 1354 is a relatively inner electrode, and the fifth electrode 1355 is a relatively outer electrode. Although the third electrode 1353 is divided into two electrodes by the above-mentioned concentric circles here, it may be divided into three or more electrodes by a plurality of concentric circles.

When the fourth electrode 1354 and the fifth electrode 1355 become light passing regions, a third aperture corresponding a combined region of the fourth electrode 1354 and the fifth electrode 1355 is formed. When the fourth electrode 1354 becomes a light passing region, and the fifth electrode 1355 becomes a light blocking region, a fourth aperture corresponding to the fourth electrode 1354 is formed. That is, in the liquid crystal panel 13e, the geometric pattern formed includes, a fourth aperture pattern in which the fourth aperture is formed, in addition to the first aperture pattern, the second aperture pattern, and the third aperture patter.

According to the fourth modification, as compared with the third modification, it is possible to switch between the relatively large third aperture and the relatively small fourth aperture as the aperture used for normal imaging. That is, normal imaging can be performed by changing the aperture value.

### Second Embodiment

### Overview of Imaging Module According to Second Embodiment

An imaging module according to a second embodiment will be In the imaging module according to the second described. embodiment, a panel surface of a liquid crystal panel has an N-sided polygonal shape (where N is a natural number greater than 4). More specifically, the shape of the panel surface of the liquid crystal panel is an octagonal shape, and even more specifically, the shape of the panel surface of the liquid crystal panel is a regular octagon.

### Configuration Example of Imaging Module According to Second Embodiment

FIG. 15 is a diagram illustrating a configuration example of an imaging module according to the second embodiment. The left diagram in FIG. 15 is a front configuration diagram of an imaging module 1b according to the embodiment, illustrating a configuration example when viewed in the optical axis direction, that is, along the z direction. The right diagram in FIG. 15 is a side configuration diagram of the imaging module 1b, illustrating a configuration example of the module when viewed in a direction perpendicular to the optical axis, that is, along the x direction. As can be seen from FIG. 15, the basic configuration of the imaging module 1b according to the second embodiment is similar to that of the imaging module 1a according to the first embodiment, but the shape of a liquid crystal panel 13f is different from that of the liquid crystal panel 13a in the first embodiment.

As illustrated in FIG. 15, the imaging module 1b includes a first lens 11, a second lens 12, the liquid crystal panel 13f, an aperture mechanism 14, a cylindrical member 15, and an imaging element 16. The first lens 11, the second lens 12, the liquid crystal panel 13f, the aperture mechanism 14, the cylindrical member 15, and the imaging element 16 have the same functions and roles as the corresponding elements in the imaging module 1a. However, the panel surface of the liquid crystal panel 13f has an octagonal shape.

### Configuration Example of Liquid Crystal Panel According to Second Embodiment

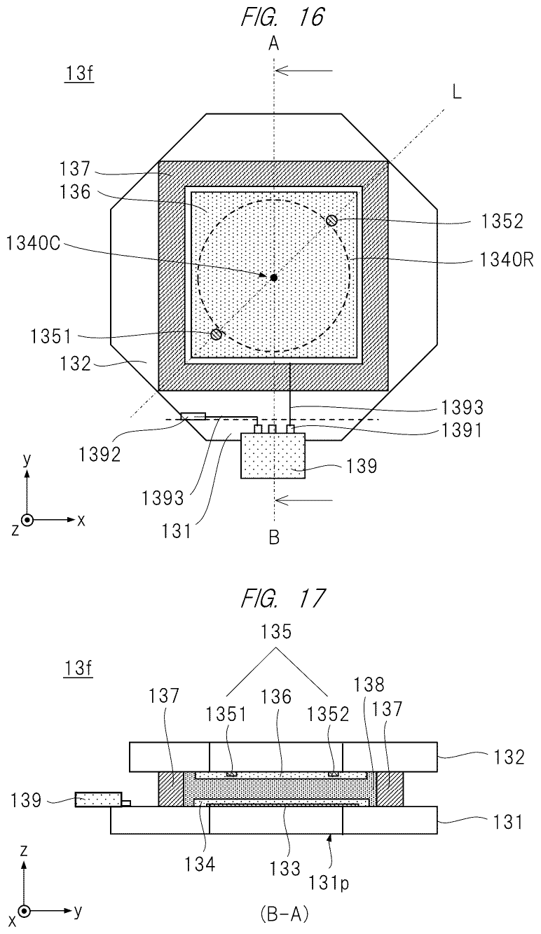

FIG. 16 is a front configuration diagram of the liquid crystal panel according to the second embodiment. FIG. 17 is a cross-sectional view of the liquid crystal panel according to the second embodiment. FIG. 17 is a cross-sectional view illustrating the liquid crystal panel illustrated in FIG. 16 taken along line A-B when viewed in the x direction.

As illustrated in FIGS. 16 and 17, the liquid crystal panel 13f has an array substrate 131, a counter substrate 132, an array substrate side electrode 133, an array substrate side alignment film 134, a counter substrate side electrode 135, a counter substrate side alignment film 136, a seal 137, and liquid crystal 138. The counter substrate side electrode 135 includes a first electrode 1351 and a second electrode 1352.

The array substrate 131 has a flat substrate surface corresponding to the panel surface 131p of the liquid crystal panel 13f. The panel surface 131p of the array substrate 131 has a shape of regular octagon when viewed in the z direction. Also, it is assumed that the liquid crystal panel 13f is disposed so that the array substrate 131, which is a component thereof, is inscribed on the cylindrical member 15. Therefore, it is a preferable example that the array substrate 131 has a shape of regular octagon.

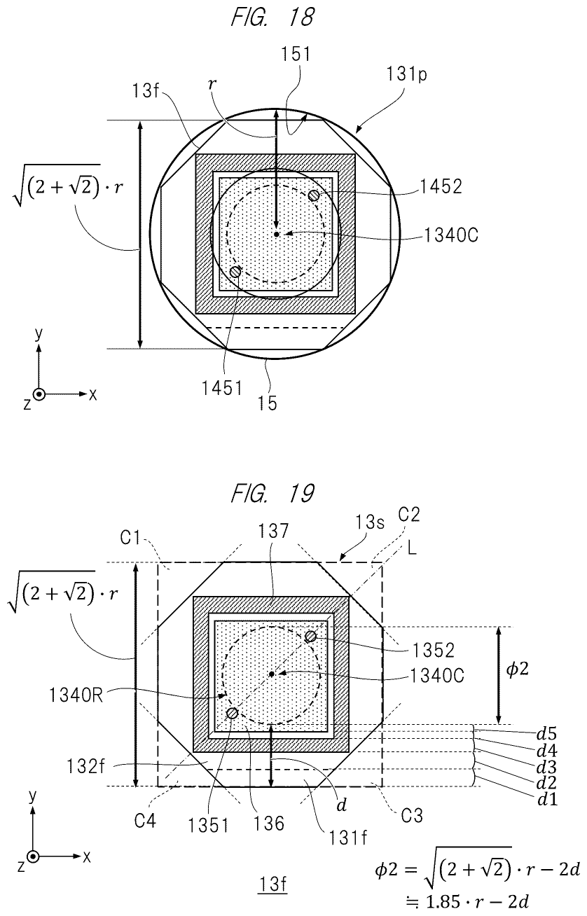

FIG. 18 is a diagram illustrating the internal configuration example of the cylindrical member in the imaging module according to the second embodiment. FIG. 19 is a diagram illustrating a configuration example of the liquid crystal panel in the imaging module according to the second embodiment.

As illustrated in FIG. 18, the panel surface 131p of the liquid crystal panel 13f has a regular octagonal shape as described above, and is disposed so as to be inscribed on the cylindrical inner surface 151 of the cylindrical member 15. That is, the panel surface 131p has a size such that it is inscribed on the cylindrical inner surface 151. The inner radius r of the cylindrical member 15 is the same as that of the imaging module 1a. In this case, the distance between the facing end sides on the panel surface 131p of the liquid crystal panel 13f is given by √(2+√2)·r=1.85·r. That is, it can be understood that the distance between the facing end sides on the panel surface 131p of the liquid crystal panel 13f is greater than the corresponding distance in the case of the imaging module 1a, which is V2.r =1.41·r. On the other hand, the distance d from the end of the specific circular region 1340R to the end of the array substrate 131, that is, the minimum sum of the distances d1 to d5 illustrated in FIG. 19, is a fixed value due to the condition from the manufacturing design, as in the case of the imaging module 1a.

Therefore, the respective positions of the outer ends of the array substrate 131, the counter substrate 132, the specific circular region 1340R, the array substrate side electrode 133, alignment film 134, the counter the array substrate side substrate side electrode 135, the counter substrate side alignment film 136, and the seal 137 are shifted further outward compared to the case of the imaging module 1a. It can be seen that the diameter φ1 specific circular region 1340R is greater than φ1. That is, the size of the specific circular region 1340R relative to the cross-sectional a of the cylindrical member 15 can be made larger than in the case of the imaging module 1a.

The reason for this effect is that the distance from the cylindrical inner surface 151 of the cylindrical member 15 to the farthest end of the panel surface of the liquid crystal panel 13f is shortened, so that the outer ends of the seal 137, the array substrate side alignment film 134, and the counter substrate side alignment film 136 can be pushed further outward. Therefore, if the panel surface 131p of the liquid crystal panel 13f has an N-sided polygonal shape, where N is a natural number greater than 4, the outer ends of the seal 137, the array substrate side alignment film 134, and the counter substrate side alignment film 136 can be pushed outward more than in the case of the imaging module 1a, making it possible to make the specific circular region 1340R larger. As a result, the first electrode 1351 and the second electrode 1352 configuring the counter substrate side electrode 135 can also be disposed further outward, allowing the baseline length between the first aperture and the second aperture to be longer.

Furthermore, when the panel surface 131p of the liquid crystal panel 13f has a size such that it is inscribed on the cylindrical inner surface 151 of the cylindrical member 15, the specific circular region 1340R can be maximized. However, in terms of mounting, it is conceivable to fix the liquid crystal panel 13f to the cylindrical inner surface 151 via a stay or the like. In this case, it is considered that the panel surface 131p may be slightly smaller than the size inscribed on the cylindrical inner surface 151 of the cylindrical member 15, however, compared with when the panel surface is rectangular, it is possible to make the specific circular region 1340R sufficiently large.

From the above perspective, it is preferable that the panel surface of the liquid crystal panel 13f has a regular N-sided polygonal shape among N-sided polygonal shapes. And the larger N is, the more preferable it is. In other words, ultimately, it is most advantageous when N=∞ (infinity), and from the standpoint of expanding the baseline length between the first aperture and the second aperture, it is most preferable for the panel surface 131p to have a circular shape and a cross-sectional area approximately the same as the cross-section of the cylindrical member 15. That is, whether the panel surface 131p is an N-sided polygonal shape or a circular shape, s if is preferable that the panel surface 131p has a size inscribed on the cylindrical inner surface 151 of the cylindrical member 15.

On the other hand, when attempting to manufacture a liquid crystal panel having the panel surface 131p of an N-sided polygonal shape where N is a relatively large number, another problem emerges. In reality, due to limitations in the functionality of a manufacturing apparatus, it is conceivable that, first, a crystal panel having the panel surface 131p of a rectangular shape is manufactured, and then, a linear cutting process is repeated so that panel surface 131p has an N-sided polygonal shape. In this case, if the number of linear cutting process increases, the number of steps increases, which increases the manufacturing cost and the time required for manufacturing. In other words, it is necessary to consider the balance between the benefits obtained and cost. One example of a case where this balance is appropriate is to make the panel surface octagonal.

As illustrated in FIG. 19, first, a liquid crystal panel 13s having the panel surface 131p of a rectangular shape is manufactured, which can be easily manufactured using a general manufacturing apparatus. Next, four corners C₁ to C₄ of the liquid crystal panel 13s are cut with a cutter. In this manner, the liquid crystal panel 13f having the panel surface 131p of an octagonal shape can be manufactured through simple and fewer processes. Further, with the panel surface being octagonal, a gap is created between the cylindrical inner surface of the cylindrical member 15 and the panel surface 131p, and through which, the flexible printed circuit board 139, its connection cable and the like, can be passed, making the design easier in terms of mounting.

The panel surface 131p of the liquid crystal panel 13f has preferably a regular octagonal shape among octagonal shapes. First, it is considered easy to manufacture the panel surface 131p of the liquid crystal panel 13s in a square shape. Next, by simply cutting the four corners C₁ to C₄ of the liquid crystal panel 13s having a square panel surface 131p linearly at a specified angle, the liquid crystal panel 13f having a panel surface 131p of a regular octagonal shape can be manufactured.

When cutting the liquid crystal panel 13s, the positions of the seal 137, the array substrate side alignment film 134, and the counter substrate side alignment film 136 may be adjusted in advance on the assumption that the liquid crystal panel 13s will be cut.

Here, in the case where the liquid crystal panel 13f is disposed so as to be inscribed on the cylindrical inner surface of the cylindrical member 15, the diameter q2 of the specific circular region 1340R can be expressed by the following formula (4).

$$\begin{matrix}( Expression 4 ) & \\ \begin{matrix}ϕ2 = \sqrt{( 2 + \sqrt{2} )} \cdot r - 2 d \\ \dot{{=}_{.}} 1.85 \cdot r - 2 d\end{matrix} & ( 4 )\end{matrix}$$

Here, r and d are defined in the same manner as in the first embodiment. The distance d1 is, for example, 3 mm. The distance d2 is, for example, 1 mm. The distance d3 is, for example, 3 mm. The distance d4 is, for example, 1 mm. The distance d5 is, for example, 1 mm. In this case, the distance d is 9 mm. If the inner cylindrical radius r of the cylinder is, 15 mm, the diameter φ2 of the particular circular region 1340R can be calculated as follows:

$$\begin{matrix}[ Expression 5 ] & \\ \begin{matrix}ϕ2 = \sqrt{( 2 + \sqrt{2} )} \cdot r - 2 d \\ \dot{{=}_{.}} 1.85 \times 15 - 2 \times 9 \\ = 27.75 - 18 \\ = 9.75 [ mm ]\end{matrix} & ( 5 )\end{matrix}$$

According to the second embodiment, since the panel surface 131p of the liquid crystal panel 13f has a polygonal shape (N is a natural number greater than 4), the specific circular region 1340R on the panel surface 131p can be made larger relative to the cross-sectional size of the cylindrical member 15. Further, if the panel shape of the liquid crystal panel 13f has a regular N-sided polygonal shape, the electrode portion of the liquid crystal panel 13f can be made even larger relative to the cross-sectional size of the cylindrical member 15.

When the panel surface 131p of the liquid crystal panel is to be octagonal, the panel surface 131p can be formed by simply cutting off the four corners of the liquid crystal panel 13s, which has the rectangular panel surface 131p. Therefore, in this case, the size of the specific circular region 1340R in the liquid crystal panel 13f can be increased to a size close to the upper limit while suppressing the additional number of steps or manufacturing cost. As a result, the baseline length, which is the distance between the first aperture corresponding to the first electrode 1351 and the second aperture corresponding to the second electrode 1352, can be extended to a length close to the upper limit.

Further, When the panel surface 131p of the liquid crystal panel 13f is to be a regular octagonal, the specific circular region 1340R of the liquid crystal panel 13f can be made even larger relative to the cross-sectional size of the cylindrical member 15. As a result, the baseline length can be further extended.

Also, when the panel surface 131p of the liquid crystal panel 13f is to be circular, the specific circular region 1340R in the liquid crystal panel 13f can be made the largest relative to the cross-sectional size of the cylindrical member 15, and the above-mentioned baseline length can be made the longest.

The shape of the panel surface 131p of the liquid crystal panel 13f may be formed by manufacturing the liquid crystal panel 13s, which has the rectangular panel surface 131p, and then cutting off any excess portions. Also, the array substrate 131 and the counter substrate 132 may be formed in advance so that the panel surface has a desired shape, and then assembled.

### Third Embodiment

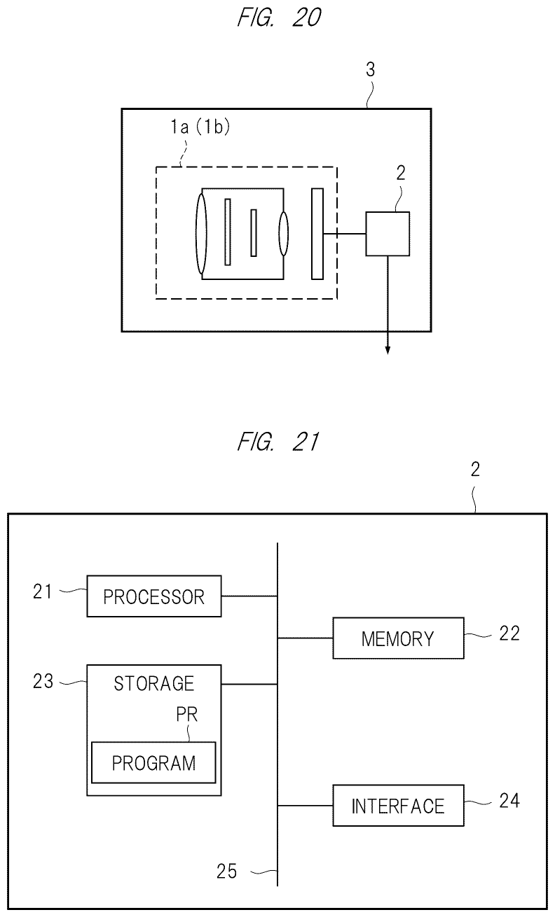

FIG. 20 is a diagram illustrating a configuration example of an imaging device according to a third embodiment. As illustrated in FIG. 20, an imaging device 3 according to the third embodiment includes the imaging module 1a according to the first embodiment and an arithmetic and control unit 2. The panel surface 131p of the liquid crystal panel 13a is inscribed on the cylindrical inner surface of the cylindrical member 15. The imaging module 1a and the arithmetic and control unit 2 are electrically connected to each other so as to be able to communicate with each other. The arithmetic and control unit 2 controls the imaging module 1a so that stereo imaging is performed using the first aperture and the second aperture, and estimates the three-dimensional position of the subject based on the imaged image acquired by the stereo imaging.

More specifically, the arithmetic and control unit 2 transmits a control signal to the liquid crystal panel 13a to form a specified aperture pattern. Also, the arithmetic and control 2 transmits a control signal to the aperture mechanism 14, and controls the size of the aperture of the aperture mechanism 14 so that the exposure when stereo imaging is performed becomes the set exposure. The arithmetic and control unit 2 controls the imaging element 16 or controls the accumulation time of a signal received from the imaging element 16 so that the imaging module 1a performs coded imaging of the subject.

The arithmetic and control unit 2 receives data of imaged image acquired by stereo imaging from the imaging element 16. Also, the arithmetic and control unit 2 calculates an estimation value of three-dimensional position of the subject using triangulation based on the parallax of the subject in the imaged image acquired by stereo imaging. Further, the arithmetic and control unit 2 generates a depth map by superimposing the estimation value of three-dimensional position of the subject on the image of the subject acquired by the first aperture or the second aperture, and outputs the depth map to an external device. The external device is, for example, a driving assistance device, an automatic braking device, and the like for a vehicle.

In the imaging device 3 according to the third embodiment, the imaging module 1b may be used in place of the imaging module 1a. Further, instead of the liquid crystal panel 13a, any one of the liquid crystal panels 13b to 13f may be used.

FIG. 21 is a diagram illustrating a configuration example of the arithmetic and control unit according to the third embodiment. As illustrated in FIG. 21, the arithmetic and control unit 2 includes, for example, a processor 21, a memory 22, a storage 23, an interface 24, and a communication bus 25. The processor 21, the memory 22, the storage 23, and the interface 24 are each connected to the communication bus 25, and are capable of communicating with each other via the communication bus 25.

The processor 21 is, for example, a central processing unit (CPU), a micro processor unit (MPU), or a micro controller unit (MCU). The memory 22 is, for example, a semiconductor storage device such as a random access memory (RAM) or a read only memory (ROM). The storage 23 is, for example, a semiconductor storage device such as a solid state drive (SSD) or a magnetic storage device such as a hard disk drive (HDD). The storage 23 stores a program PR. By reading and executing the program PR, the processor 21 implements the function of performing various processes as described above, such as control processing for coded imaging, processing for calculating an estimation value of three-dimensional position of a subject, and processing for generating a depth map. The interface 24 outputs the generated depth map, and the like to the external device. The program PR may be stored in a ROM.

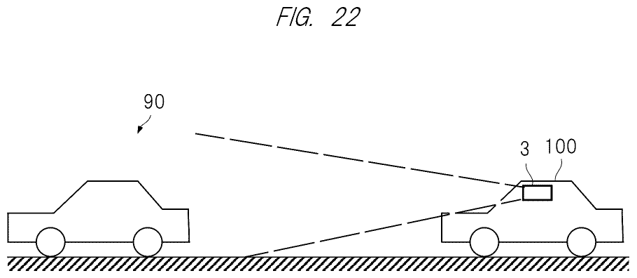

FIG. 22 is an application example of the imaging device according to the third embodiment. As illustrated in FIG. 22, the imaging device 3 is installed in, for example, an automobile 100, performs three-dimensional position estimation of a subject 90 in front, generates a depth map of the subject 90, and outputs the depth map to a driving assistance system or the like. The imaging device 3 may be installed on vehicles other than automobiles, such as railway or monorail trains, monorail cars, motorcycles, airplanes, ships, and the like. Even in such an installation example, the imaging device 3 provides the same effects as those in the above embodiments, and can be used in, for example, driving assistance technique.

Although various embodiments of the present disclosure have been described above, the present disclosure is not limited to the above-described embodiments and includes various modifications. Further, the above-described embodiments have been described in detail to clearly describe the present disclosure, and the present disclosure is not necessarily limited to having all of the configurations described. Further, it is possible to replace part of the configuration of one embodiment with the configuration of another embodiment, and it is also possible to add the configuration of another embodiment to the configuration of one embodiment. All of these fall within the scope of the present disclosure. Furthermore, the numerical values and the like contained in the text and drawings are merely examples, and the effects of the present disclosure will not be impaired if different values are used.

What is claimed is:

1. An imaging module comprising:
a lens;
a liquid crystal panel having a panel surface perpendicular to an optical axis of the lens;
a cylindrical member having a cylindrical shape and supporting the lens and the liquid crystal panel in an inside of cylinder; and
the liquid crystal panel includes an array substrate, a counter substrate, an array substrate side electrode, an array substrate side alignment film, a counter substrate side electrode, a counter substrate side alignment film, liquid crystal present between the array substrate and the counter substrate, and a seal provided between the array substrate and the counter substrate and sealing the liquid crystal, and forms a specified geometric pattern under control of a voltage applied to the array substrate side electrode and the counter substrate side electrode,
wherein the panel surface has a shape of regular N-sided polygon, where N is a natural number equal to or greater than 4,
wherein the geometric pattern includes a pattern in which a first aperture, which is a light passing region, is formed, and a pattern in which a second aperture, which is a light passing region, is formed,
wherein the first aperture is formed in one of two regions on the panel surface that are spaced apart from each other by a distance greater than a diameter of a specific circular region, so as to interpose the specific circular region therebetween,
wherein the second aperture is formed in an other of the two regions,
wherein the specific circular region has a center on a central axis in the inside of cylinder and has a diameter φ1 expressed by a following formula:
$$φ 1 = √ 2 \times r - 2 \times d$$
√2: a positive square root of 2,
r: a radius of the inside of cylinder,
d: in a case where the seal is disposed in a region of the counter substrate, an alignment film is disposed inside a frame formed by the seal, a circular electrode is disposed in a region of the alignment film, and a flexible printed circuit board connected to both the array substrate side electrode and the counter substrate side electrode is disposed at an one end side portion of the array substrate, a shortest possible distance, from a manufacturing design perspective, from an end side of the one end side portion to the circular electrode in a direction parallel to the panel surface.

2. The imaging module according to claim 1,
wherein centers or centroids of the first aperture and the second aperture are located on a straight line passing through a center of the specific circular region.

3. The imaging module according to claim 1,
wherein the center or the centroid of one of the first aperture and the second aperture, which is relatively closer to the one end side of the one end side portion of the array substrate, is positioned on a straight line passing through a center of the specific circular region, and
wherein the center or the centroid of one of the first aperture and the second aperture, which is relatively farther away from the end side of the one end side portion from the straight line, is positioned at a position away from the end side of the one end side portion of the array substrate.

4. The imaging module according to claim 1,
wherein the regular N-sided polygon is a regular octagon.

5. The imaging module according to claim 1,
wherein the distance d is a sum of a distance d1, a distance d2, a distance d3, a distance d4, and a distance d5 in a direction parallel to the panel surface,
wherein the distance d1 is a distance from one end side of the array substrate on a first side on which a flexible printed circuit board is disposed to one end side of the counter substrate on the first side,
wherein the distance d2 is a distance from the one end side of the counter substrate on the first side to the seal,
wherein the distance d3 is a distance corresponding to the width of a band of a frame formed by the seal,
wherein the distance d4 is a distance from the seal to the counter substrate side alignment film, and
wherein the distance d5 is a distance from the counter substrate side alignment film to the specific circular region.

6. The imaging module according to claim 1,
wherein the geometric pattern includes a pattern in which a third aperture corresponding to the specific circular region is formed.

7. The imaging module according to claim 6,
wherein the geometric pattern includes a pattern in which a third aperture corresponding to the specific circular region is formed.

8. An imaging device comprising:
an imaging module; and
an arithmetic and control unit,
wherein the imaging module includes
a lens,
a liquid crystal panel having a panel surface perpendicular to an optical axis of the lens,
a cylindrical member having a cylindrical shape and supporting the lens and the liquid crystal panel in an inside of cylinder, and
an imaging element that receives light from a subject that has passed through the lens and the liquid crystal panel,
the liquid crystal panel includes an array substrate, a counter substrate, an array substrate side electrode, an array substrate side alignment film, a counter substrate side electrode, a counter substrate side alignment film, liquid crystal present between the array substrate and the counter substrate, and a seal provided between the array substrate and the counter substrate and sealing the liquid crystal, and forms a specified geometric pattern under control of a voltage applied to the array substrate side electrode and the counter substrate side electrode,
wherein the panel surface has a shape of regular N-sided polygon, where N is a natural number equal to or greater than 4,
wherein the geometric pattern includes a pattern in which a first aperture, which is a light passing region, is formed, and a pattern in which a second aperture, which is a light passing region, is formed,
wherein the first aperture is formed in one of two regions on the panel surface that are spaced apart from each other by a distance greater than a diameter of a specific circular region, so as to interpose the specific circular region therebetween,
wherein the second aperture is formed in an other of the two regions,
wherein the specific circular region has a center on a central axis in the inside of cylinder and has a diameter q1 expressed by a following formula:
$$φ 1 = √ 2 \times r - 2 \times d$$
√2: a positive square root of 2,
r: a radius of the inside of cylinder,
d: in a case where the seal is disposed in a region of the counter substrate, an alignment film is disposed inside a frame formed by the seal, a circular electrode is disposed in a region of the alignment film, and a flexible printed circuit board connected to both the array substrate side electrode and the counter substrate side electrode is disposed at an one end side portion of the array substrate, a shortest possible distance, from a manufacturing design perspective, from an end side of the one end side portion to the circular electrode in a direction parallel to the panel surface, and
wherein the arithmetic and control unit controls the imaging module and the imaging element so that stereo imaging using the first aperture and the second aperture is performed, and calculates an estimation value of three-dimensional position of the subject based on an imaged image acquired by the stereo imaging.

9. The imaging device according to claim 8,
wherein centers or centroids of the first aperture and the second aperture are located on a straight line passing through a center of the specific circular region.

10. The imaging device according to claim 8,
wherein the center or the centroid of one of the first aperture and the second aperture, which is relatively closer to the one end side of the one end side portion of the array substrate, is positioned on a straight line passing through a center of the specific circular region, and
wherein the center or the centroid of one of the first aperture and the second aperture, which is relatively farther away from the end side of the one end side portion from the straight line, is positioned at a position away from the end side of the one end side portion of the array substrate.

11. The imaging device according to claim 8,
wherein the regular N-sided polygon is a regular octagon.

12. The imaging device according to claim 8,
wherein the distance d is a sum of a distance d1, a distance d2, a distance d3, a distance d4, and a distance d5 in a direction parallel to the panel surface,
wherein the distance d1 is a distance from one end side of the array substrate on a first side on which a flexible printed circuit board is disposed to one end side of the counter substrate on the first side,
wherein the distance d2 is a distance from the one end side of the counter substrate on the first side to the seal,
wherein the distance d3 is a distance corresponding to the width of a band of a frame formed by the seal,
wherein the distance d4 is a distance from the seal to the counter substrate side alignment film, and
wherein the distance d5 is a distance from the counter substrate side alignment film to the specific circular region.

13. The imaging device according to claim 8,
wherein the geometric pattern includes a pattern in which a third aperture corresponding to the specific circular region is formed.

14. The imaging device according to claim 13,
wherein the geometric pattern includes a pattern in which a third aperture corresponding to the specific circular region is formed.
